(19) United States
(12) Patent Application Publication
(10) Pub. No.: US 2002/0029895 A1
(43) Pub. Date: Mar. 14, 2002

(54) Cable terminal

(76) Inventor: Joachim Jacke, Paderborn (DE)

Correspondence Address: NIXON PEABODY, LLP, 8180 GREENSBORO DRIVE, SUITE 800, MCLEAN, VA, 22102, US

(21) Appl. No.: 09/924,871

(22) Filed: Aug. 9, 2001

(30) Foreign Application Priority Data
Aug. 9, 2000 (DE) 100 39 632.1
Jan. 26, 2001 (DE) 101 03 744.9

(51) Int. Cl. H01R 4/00

(52) U.S. Cl. 174/88 R

(57) ABSTRACT

A cable terminal or joining means (1) for end-face connection of the conductors (2) of a preferably multicore cable (3) is described, with one plug part (7) which is provided with contact elements (5), with a core holding and guiding part (8) and with a cable receiver (9), the core holding and guiding part (8) having core guidance channels (10) and the plug part (7) and the cable receiver (9) can be connected to one another, especially screwed to one another, and in the assembled state the core holding and guiding part (8) being located between the plug part (7) and the cable receiver (9) and being surrounded by the plug part (7) and the cable receiver (9).

In the cable terminal or joining means (1) shown as claimed in the invention, alignment of the individual cores (4) to the contact elements (5) of the plug part (7) as accurate as possible is accomplished by the core holding and guiding part (8) consisting of a first section (11) of soft material, and of a second section (12) of hard material, and in the first section (11) the core guidance channels (10) and in the second section (12) a positioning aid (13) being formed for exact alignment of the conductors (2) to the contact elements (5).

The invention relates to a cable terminal or joining means for end-face connection of the conductors of a preferably multicore cable, with one plug part which is provided with contact elements, with a core holding and guiding part and with a cable receiver, the core holding and guiding part having core guidance channels and the plug part and the cable receiver can be connected to one another, especially screwed to one another, and in the assembled state the core holding and guiding part being located between the plug part and the cable receiver and being surrounded by the plug part and the cable receiver.

First of all, it will be explained below which of the terms used in the following description, first of the prior art, and then of the invention, have or are to have what meaning.

a) The term “cable” means an electrical line which has at least one core, but generally several cores; if there are several cores, it is a multicore cable. For only one core it is a single-core cable.

b) The cores of a cable consist of a conductor and core insulation.

c) In one cable the inherently insulated conductors, therefore the conductors provided with core insulation, in their totality are surrounded by other insulation, the cable insulation. For a single-core cable there is no other insulation besides the core insulation.

It was stated at the beginning that the invention relates to a cable terminal or joining means for end-face connection of the conductors of a multicore cable. Here the cable can be connected to an electrical device or can be joined in an electrically conductive manner to a second cable. If the cable is connected to an electrical device, it is a terminal means. If two cables are to be connected to one another, it is a joining means. Regardless of whether it is a terminal or a joint, the cable or conductor is always connected by a contact element. Mainly a terminal means is emphasized below. But a joining means in the aforementioned sense is also always intended.

In a terminal means for electrically conductive connection of a cable to an electrical device, the electrical device should be understood quite in general; in particular the expression “electrical device” also includes electrical and electronic components, means and devices.

It was stated initially that the cable terminal or joining means is intended for end-face connection of the conductors of a multicore cable. First of all, it is conventional in practice for multicore cables to be connected, but basically the cable terminal or joining means can also be used for those cables which have only one core.

With the initially described cable terminal or joining means generally cables are connected in which the cable insulation, but not the core insulation of the individual cores, has been removed before connection. The cable terminal or joining means thus enables connection of unstripped conductors. Possibilities for connecting unstripped conductors are already known from the prior art. For this purpose so-called insulation piercing connecting devices or insulation displacement terminal means are used in which the contact elements which are generally made as contact blades cut into the core insulation from laterally outside until contact is made with the conductor. In addition, there is a second possibility for connecting unstripped conductors in which the contact elements which are generally made as contact spikes do not pierce the core insulation, but penetrate into the conductor and/or the core insulation from the end face of the cores roughly in the direction of the lengthwise axis of the cores and make contact with the conductor.

In the cable terminal or joining means to be formed with this invention the second possibility is used, i.e. the core insulation is not cut from the side, but the conductors are connected from the end face. In doing so, generally in this connection stranded conductors are used in which thus the contact element penetrates between the individual strands of the conductor. As a result of the restoration force of the core insulation, there is a clamping force sufficient for making electrical contact between the individual strands of the conductor and the contact element which has penetrated into the conductor.

German patent 44 18 259 discloses a cable terminal or joining means of the type under consideration, in which the core holding and guiding part consists of a plug-side gland and a cable-side end part. In the installed state of the cable terminal or joining means the gland is pushed into a corresponding recess in the plug part. The alignment of the individual conductors to the contact elements takes place by there being four axially parallel channels for holding the cores in the core holding and guiding part and they are flush with the contact elements in the installed state. Here the inside diameter of the channels is slightly less than the outside diameter of the cores, by which on the one hand clamping of the cores takes place, on the other via the corresponding alignment of the gland to the contact elements the cores are also aligned to the contact elements. In addition, the cable-side end part of the core holding and guiding part is made elastic by the lengthwise slots located in the end part, by which clamping of the individual cores can be achieved for forces acting accordingly radially on the end part.

In the above described known cable terminal or joining means exact alignment of the individual cores to the contact elements is dependent on the production tolerances of the gland of the core holding and guiding part to the corresponding recess of the plug part. In addition, for different cables with different diameters of the cores different core holding and guiding parts are necessary. If a cable which is used has cores with smaller diameters than the core guidance channels, the alignment of the cores to the contact elements is inadequate.

German utility model 298 17 679 likewise discloses a cable terminal or joining means of the type under consideration, but which enables connection of different cables with different core cross sections. To do this the core holding and guiding part consists of a rubber elastic material with axially parallel channels located in it. By squeezing the rubber elastic material together in the radial direction the channel cross section is matched to the actual cross section of the inserted cores. But here the disadvantage is that by squeezing together the rubber elastic material of the core holding and guiding part not only the channel cross section, but also the alignment of the channel middle to the contact elements are changed. Thus, insertion of cores with different diameters into the core guidance channels of the core holding and guiding part is indeed possible, but the accuracy of alignment of the inserted cores to the contact elements likewise depends on the core cross sections used, so that exact alignment cannot always be ensured. In addition, the alignment of the cores is adversely affected by aging and settling phenomena of the rubber elastic core holding and guiding part.

Thus the object of this invention is to make available a cable terminal or joining means for end-face connection of the conductors of a multicore cable in which alignment of the individual cores as exact as possible to the contact elements of the plug part is accomplished. In addition, within certain limits, different cables with different core cross sections are to be connected with the same cable terminal or joining means.

The aforementioned object is first of all achieved essentially in that the core holding and guiding means consists of a first section of soft material and a second section of hard material and that in the first section the core guidance channels and in the second section a positioning aid are formed for exact alignment of the conductors to the contact elements; “soft material” means one which is relatively elastic, “hard material” means one which has little elasticity.

The embodiment of the core holding and guiding means as claimed in the invention enables first of all connection of different cables with different core cross sections. By the arrangement of the core guidance channels in the first section of the core holding and guiding part which consists of soft material, especially of a soft plastic, for example a thermoplastic elastomer, the cross section of the core guidance channels can be reduced to the smaller cross section of the cores by radial pressure on this first section. In doing so, as a result of the elastic properties of the first section, sufficient clamping of the individual cores into the core guidance channels can be achieved so that the cores are prevented from slipping back when the contact elements penetrate into the cores. The radial pressure on the first section moreover provides for the contact force necessary for making electrical contact between the individual strands of a conductor and the contact element which has been pushed into the conductor from the end face. The force acting radially on the core insulation thus additionally supports the restoration force of the core insulation. Because the alignment of the cores or the conductors to the contact elements is accomplished by a positioning aid which is formed in the second section of the core holding and guiding part, exact alignment of the conductors to the contact elements is not influenced by the core guidance channels being pressed together. Because the second section consists of a hard plastic, especially of a hard thermoplastic or of a ceramic material or other hard insulating material, the positioning aid is much less sensitive to aging and settling phenomena.

The thermoplastic elastomers for the first section can be for example a natural rubber or a silicone rubber, and the first section can be produced by vulcanization.

According to one especially preferred embodiment of the invention, the first section is made in one piece from thermoplastic elastomer and the second section is made in one piece from thermoplastic. Here the core holding and guiding part can be produced in a two-component injection molding process so that the two sections are connected to one another materially. The advantage of this core holding and guiding part which is made as a composite injected part is that in this way it is easily ensured that the first section and the second section cannot slide or turn relative to one another.

According to one preferred embodiment of the positioning aid, it has holes assigned to the individual core guidance channels, the holes, viewed from the core guidance channels, having a tapering cross section. The holes can be made especially funnel-shaped or cone-shaped. By this configuration of the positioning aid, solely by pushing the cores through the core guidance channels into the tapering holes “self-alignment” of the inserted cores is accomplished. Exact, permanent alignment of the center lines of the cores, regardless of their diameter, is always accomplished by the funnel-shaped or cone-shaped execution of the holes. If the contact elements of the plug part are arranged such that they are centered to the holes of the positioning aid, it is always ensured that the contact elements also meet the end face of the cores to be connected in the center.

The arrangement and alignment of the contact elements exactly centered to the holes of the positioning aid can advantageously be accomplished especially easily by the holes of the first tapering area which adjoins the core guidance channels having a second area of constant diameter and a third, widening area. The positioning aid is then used not only to align the cores, but at the same time also to align the contact elements, exact alignment of the cores to the contact elements being accomplished by the hole overall and thus all three areas having a coincident center line.

It was stated above that the holes have a first tapering area, a second area of constant diameter and a third widening area. Here the first and the third area are made mirror-symmetrical to one another and even border one another so that the middle second area is more or less omitted or only has a negligible length. The minimum diameter of the first tapering area must always be less than the smallest diameter of the core to be connected so that the first area of the hole always forms a stop for a core which has been pushed through a core guidance channel. Conversely the smallest diameter of the third area must always be greater than the diameter of the contact elements so that the contact elements project through the holes into the area of the core guidance channels. Ideally, the smallest diameter of the third area corresponds exactly to the outside diameter of the contact elements.

In the cable terminal or joining means as claimed in the invention the embodiment of the core holding and guiding part described in particular above is essential to the invention. The subject matter of this invention is thus not only the cable terminal or joining means, but also the core holding and guiding part for use in a cable terminal or joining means. For the specific embodiment of the cable terminal or joining means, especially of the plug part and cable receiver, there are various possibilities. What is functionally important is simply that the plug part and/or the cable receiver are made such that on the one hand the plug part and the cable receiver can be connected to one another, that on the other hand radial forces are applied especially to the first section of the core holding and guiding part which consists of a soft, elastic material.

According to one advantageous embodiment of the cable terminal or joining means as claimed in the invention, there is a polarization element which acts between the plug part and the cable receiver. For this purpose for example the second section has a groove and the plug part has an assigned spring. Of course, the groove can also be assigned to the plug part and the spring to the second section or the polarization element can be made differently. This polarization element ensures polarized connection of a cable to the contact elements of the plug part.

According to one advantageous embodiment of the cable terminal or joining means as claimed in the invention the cable receiver has a sleeve with an outside thread and the plug part has a coupling ring with an inside thread which corresponds to the outside thread of the sleeve. Thus, to assemble the cable terminal or joining means as claimed in the invention the cable receiver and the plug part can be easily screwed together, the core holding and guiding part being located between the cable receiver and the plug part.

The radial force on the core holding and guiding part can be easily produced by the plug part's having a sleeve part which is located within the coupling ring, the sleeve part in the installed state surrounding the core holding and guiding part and the inside diameter of the sleeve part being at least partially smaller than the outside diameter of the core holding and guiding part. A radial force can thus be applied to the first section of the core holding and guiding part by the arrangement of this sleeve part in the plug part, by which the core guidance channels are squeezed together and the cores which have been inserted into the core guidance channels are secured. Especially advantageous clamping of the cores in the core guidance channels in the vicinity of the positioning aid is achieved by the inside diameter of the sleeve part widening in the direction to the core holding and guiding part, in other words, the sleeve part has the smallest diameter on the side facing away from the cable receiver.

In particular, there are a host of possibilities for embodying and developing the above described cable terminal or joining means as claimed in the invention. In this regard reference is made on the one hand to the claims subordinate to claim 1, on the other hand to the following description of one preferred embodiment in conjunction with the drawings.

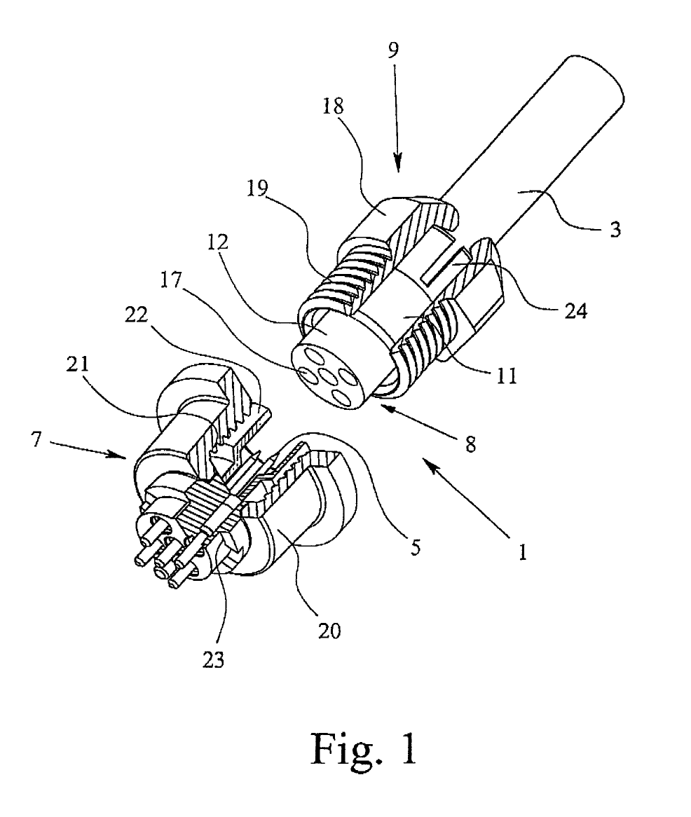

FIG. 1 shows a perspective view of a cable terminal or joining means as claimed in the invention in the opened state,

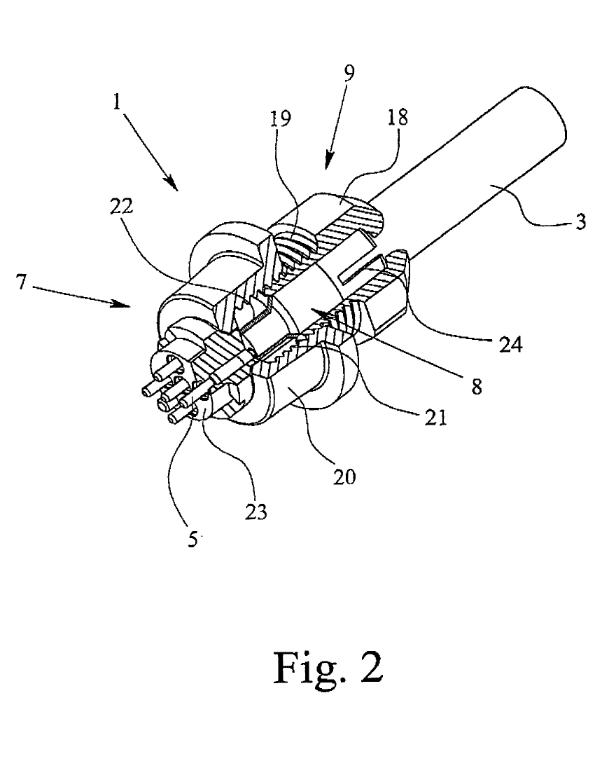

FIG. 2 shows a view of the cable terminal or joining means corresponding to FIG. 1 in the contact-making state,

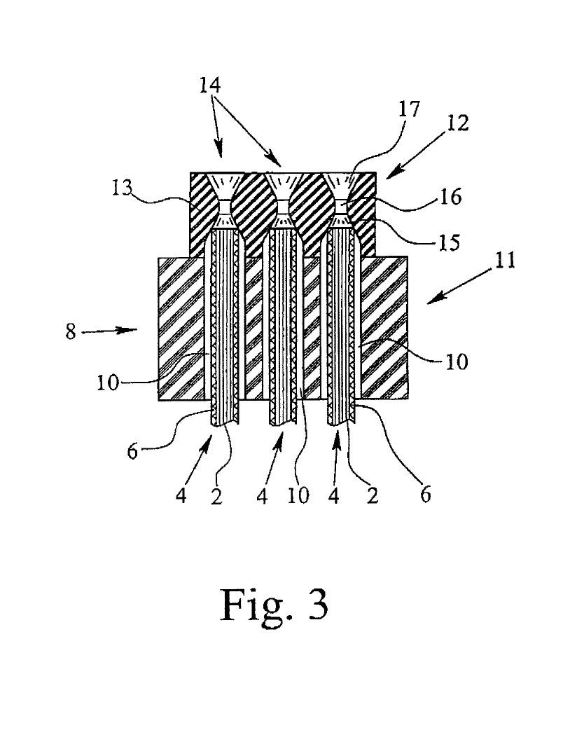

FIG. 3 shows a schematic sketch of the core holding and guiding part of a cable terminal or joining means as claimed in the invention in cross section and

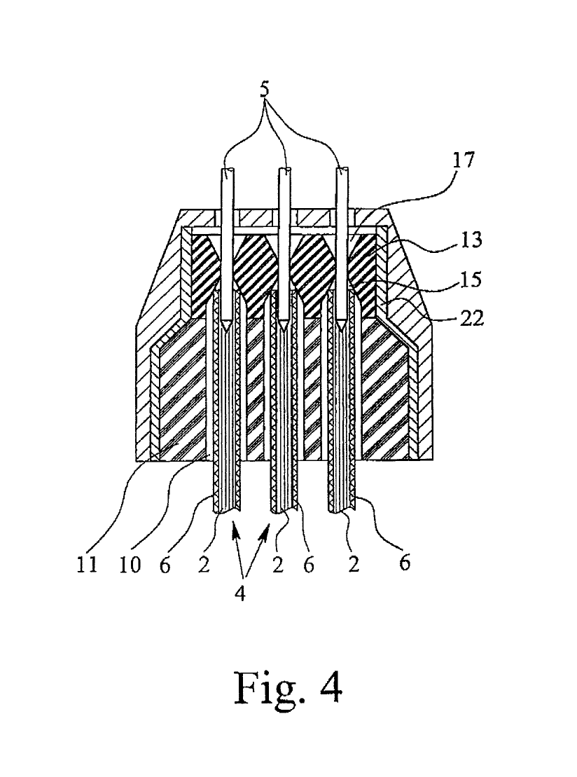

FIG. 4 shows the core holding and guiding part of a cable terminal or joining means as claimed in the invention with the inserted cores having made contact with the contact elements.

FIGS. 1 and 2 show one embodiment of a cable terminal or joining means 1 as claimed in the invention for end-face connection of the conductors of a multicore cable 3 which are shown in FIGS. 3, and 4, which cable has a total of five cores 4. The cable terminal or joining means 1 as claimed in the invention 1 enables connection of unstripped conductors 2 by the contact elements 5 penetrating into the conductor 2 from the end face of the conductor 2 roughly in the direction of the lengthwise axis of the conductor 2. In doing so generally stranded conductors 2 are used in which thus the contact element 5 penetrates between the individual strands of the conductor 2. As a result of the restoration force of the core insulations 6 which surround the individual conductors 2 there is a clamping force sufficient to make electrical contact between the individual strands of the conductor 2 and the contact element 5 which has penetrated the conductor 2.

The cable terminal or joining means 1 consists essentially of a plug part 7 in which the contact elements 5 are located, a core holding and guiding part 8 and a cable receiver 9. To connect a cable 3 to the cable terminal or joining means 1 the individual cores 4 are pushed into the core guidance channels 10 which are provided in the core holding and guiding part 8. In the embodiment shown in FIGS. 1 and 2 there are a total of five core guidance channels 10 which are parallel to one another in the core holding and guiding part 8 so that the cable terminal or joining means 1 shown there for electrical connection of the cables 3 is provided with a maximum five cores 4. There are also five contact elements 5 in the plug part 7 corresponding to the five core guidance channels 10 which are present.

FIGS. 3 and 4 show a schematic of the core holding and guiding part 8 which as claimed in the invention consists of a first section 11 of soft material, especially of thermoplastic elastomer, and a second section 12 of a hard material, especially a hard thermoplastic or ceramic. In the first section 11 there are the core guidance channels 10, while the second section 12 of the core holding and guiding part 8 forms the positioning aid 13 for exact alignment of the conductors 2 to the contact elements 5. The core holding and guiding part 8 is preferably produced in a two-component injection molding process so that the core holding and guiding part 8 is in one piece and the first section 11 is materially connected to the second section 12.

FIG. 3 shows that the diameter of the core guidance channels 10 is greater than the diameter of the cores 4 to be connected. Here the diameter of the core guidance channels 10 is chosen such that it corresponds to the largest diameter of the cores 4 intended for connection to the cable terminal or joining means 1. Because there are core guidance channels 10 in the first section 11 of the core holding and guiding part 8 consisting of soft material, the core guidance channels 10 can be pressed together by applying a radial force to the first section 11 of the core holding and guiding part 8 to such an extent that sufficient axial fixing of the individual cores 4 in the core guidance channels 10 is achieved.

The positioning aid 13 of the core holding and guiding part 8 has holes 14 assigned to the core guidance channels 10, the holes 14 consisting of a first tapering area 15 which adjoins the core guidance channels 10, a second area 16 of constant cross section and a third, widening area 17. The first tapering funnel-shaped area 15 of the hole 14 is used for exact positioning of a core 4 which has been pushed through the core guidance channel 10. Because the first area 15 of the hole 16 tapers in a funnel shape, “self alignment” of the inserted cores 4 and thus also of the conductors 2 with which contact is to be made always takes place so that the center line of an inserted conductor 2 always agrees with the center line of the hole 14.

While FIG. 3 shows the core holding and guiding part 8 with the cores 4 inserted, but without the contact elements 5, FIG. 4 also shows the contact elements 5 inserted from the opposite direction. In the same way as the areas 15 of the holes 14 cause exact alignment of the cores 4, the conical areas 17 of the holes 14 cause exact alignment of the contact elements 5. If the outside diameter of the contact elements 5 corresponds to the smallest diameter of the hole 14, i.e. the diameter of the middle area 16, a contact element 5 which has been pushed through the hole 14 of the positioning aid 13 always meets a core 4 which has been inserted into the core guidance channel 10 exactly in the center and thus also the conductor 2 surrounded by the core insulation 6 exactly in the center. The embodiment of the positioning aid 13 described in detail above and the material connection of the first section 11 which has the core guidance channels 10 and the second section 12 of the core holding and guiding part 8 which has the positioning aid 13 ensures that the contact elements 5 always meet the end face of the conductors 2 in the center. In this way then optimum electrical contact between the conductors 2 and the contact elements 5 is ensured.

One preferred possibility for assembly of the cable terminal or joining means 1 as claimed in the invention is shown in FIGS. 1 and 2. In the embodiment shown the cable receiver 9 and the plug part 7 can be screwed to one another by the cable receiver 9 having a sleeve 18 with an outside thread 19 and the plug part 7 having a coupling ring 20 with an inside thread 21 which corresponds to the outside thread 19 of the sleeve 18. In the assembled state of the cable terminal or joining means 1 then the core holding and guiding part 8 is surrounded by the sleeve 18 and the coupling ring 20.

The plug part 17 has an inside sleeve 22 and a contact carrier 23 which holds the contact elements 5. The inside sleeve 22 which surrounds the core holding and guiding part 8 in the contact-making state by form-fit has an inside diameter which is at least partially smaller than the outside diameter of the core holding and guiding part 8. The inside contour of the inner sleeve 22 is now chosen such that in the installed state of the cable terminal or joining means 1 the first section 11 of the core holding and guiding part 8 is pressed together by the inside sleeve 22 so that the cores 4 which have been pushed into the core guidance channels 10 are clamped tight. In the embodiment of the cable terminal or joining means 1 as claimed in the invention shown which is shown in FIGS. 1 and 2 the cable receiver 9 has a clamp cage 24 which acts as strain relief for the inserted cable 3.

In addition to the implementation especially of the plug part 7 and the cable receiver 9 shown in FIGS. 1 and 2, in which the sleeve 18 is assigned to the cable receiver 9 and the coupling ring 20 to the plug part 7, a version is also possible in which the coupling ring is assigned to the cable receiver and the plug part has a sleeve with an outside thread. Likewise there can be a sleeve part which applies a radial force to the core holding and guiding part instead of in the plug part in the cable receiver.

1. Cable terminal or joining means for end-face connection of the conductors (2) of a preferably multicore cable (3), with one plug part (7) which is provided with contact elements (5), with a core holding and guiding part (8) and with a cable receiver (9), the core holding and guiding part (8) having core guidance channels (10) and the plug part (7) and the cable receiver (9) can be connected to one another, especially screwed to one another, and in the assembled state the core holding and guiding part (8) being located between the plug part (7) and the cable receiver (9) and being surrounded by the plug part (7) and the cable receiver (9), characterized in that
the core holding and guiding part (8) consists of a first section (11) of soft material, and a second section (12) of hard material and that in the first section (11) the core guidance channels (10) and in the second section (12) a positioning aid (13) are formed for exact alignment of the conductors (2) to the contact elements (5).

2. Cable terminal or joining means as claimed in claim 1, wherein the first section (11) consists of a soft plastic, especially of a thermoplastic elastomer, and the second section (12) consists of a hard plastic, especially of a hard thermoplastic or of a ceramic material.

3. Cable terminal or joining means as claimed in claim 1 or 2, wherein the first section (11) and the second section (12) are made in one piece, are connected especially materially to one another.

4. Cable terminal or joining means as claimed in one of claims 1 to 3, wherein the diameter of the individual core guidance channels (10) corresponds to the largest diameter of the cores (4) to be connected.

5. Cable terminal or joining means as claimed in one of claims 1 to 4, wherein the positioning aid (13) has holes (14) which are assigned to the individual core guidance channels (10) of the core holding and guiding part (8) and the holes (14), viewed from the core guidance channels (10), have a tapering cross section.

6. Cable terminal or joining means as claimed in claim 5, wherein the holes (14) of the positioning aid (13) are made funnel-shaped or conical.

7. Cable terminal or joining means as claimed in claim 5 or 6, wherein the holes (14) of the positioning aid (13) form a stop for the cores (4) which have been pushed through the core guidance channels (10) of the core holding and guiding part (8).

8. Cable terminal or joining means as claimed in one of claims 5 to 7, wherein the holes (14) of the positioning aid (13) have a first tapering area (15) which adjoins the core guidance channels (10) of the core holding and guiding part (8), a second area (16) of constant diameter, and a third widening area (17).

9. Cable terminal or joining means as claimed in one of claims 1 to 8, wherein there is a polarization element which acts between the plug part (7) and the cable receiver (9), for example the second section (12) has a groove and the plug part (7) has an assigned spring.

10. Cable terminal or joining means as claimed in one of claims 1 to 9, wherein the cable receiver (9) has a sleeve (18) with an outside thread (19) and a coupling ring (20) with an inside thread (21) which corresponds to the outside thread (19) of the sleeve (18) is assigned to the plug part (7).

11. Cable terminal or joining means as claimed in claim 10, wherein the plug part (7) has an inside sleeve (22) which is located within the coupling ring (20), the inside sleeve (22) in the installed state surrounds the core holding and guiding part (8) and the inside diameter of the inner sleeve (22) is at least partially smaller than the outside diameter of the core holding and guiding part (8).

12. Cable terminal or joining means as claimed in claim 11, wherein the inside diameter of the inside sleeve (22) widens in the direction to the core holding and guiding part (8).

13. Cable terminal or joining means as claimed in one of claims 1 to 12, wherein the plug part (7) has a contact carrier (23) with holes for holding the contact elements (5) and the contact elements (5) on their end facing the core holding and guiding part (8) have contact spikes.

14. Core holding and guiding part with core guidance channels (10) for use in a cable terminal or joining means for end-face connection of the conductors (2) of a preferably multicore cable (3), with one plug part (7) which is provided with contact elements (5), as claimed in one of claims 1 to 13, consisting of a first section (11) of soft material, especially thermoplastic elastomer, and a second section (12) of hard material, especially a hard thermoplastic or ceramic material, in the first section (11) the core guidance channels (10) and in the second section (12) a positioning aid (13) being formed for exact alignment of the conductors (2) to the contact elements (5).
